(19) United States
(12) Patent Application Publication
(10) Pub. No.: US 2017/0306839 A1
(43) Pub. Date: Oct. 26, 2017

(54) FOUR CYLINDER ENGINE WITH SHARED POWER EVENT

(71) Applicant: Raymond F. Lippitt, Mount Pleasant, SC (US)

(72) Inventor: Raymond F. Lippitt, Mount Pleasant, SC (US)

(21) Appl. No.: 15/483,785

(22) Filed: Apr. 10, 2017

Related U.S. Application Data
(60) Provisional application No. 62/325,218, filed on Apr. 20, 2016.

(51) Int. Cl. F02B 75/20; F02D 11/02

(52) U.S. Cl. CPC F02B 75/20; F02D 11/02

(57) ABSTRACT

A four cylinder engine including two outer cylinders valved to operate on a four cycle basis, the outer two cylinders being movable together in opposite directions than the direction of movement together of the two inner cylinders. The two inner cylinders valved to operate on a two-cycle basis. The four cylinders having fuel injectors for injecting an amount of fuel in an associated cylinder so as to cause a self-ignited power event to occur therein during each cycle. The engine, when embodied in a vehicle having a battery energized computer and manually operated accelerator pedal being selectively operated in three power levels: (1) a minimum fuel mode (2) an intermediate fuel mode and (3) a maximum fuel mode. (1) Enabling a two-third fuel saving (two injections out of a possible six) when in minimum fuel mode and (2) a one-third saving fuel (four injections out of a possible six) when in the intermediate mode. The two inner cylinders operate on the fuel sharing principles of the '769 patent when in the intermediate mode.

### CROSS REFERENCES TO RELATED APPLICATIONS

This application claims priority to U.S. Provisional Patent Application No. 62/325,218 filed Apr. 20, 2016, the entire content of which is incorporated herein by reference in its entirety.

### FIELD OF THE INVENTION

This invention relates to internal combustion engines and particularly to engines suitable to move vehicles with improved fuel economy and specifically improved MPG (miles per gallon).

### SUMMARY OF THE INVENTION

The present invention utilizes fuel saving principles disclosed in U.S. Pat. No. 8,443,769, the disclosure of which is hereby incorporated by reference into the present disclosure. The engine configurations disclosed in the '769 patent are particularly suited for heavy truck operation.

### BRIEF DESCRIPTION OF THE INVENTION

The present invention is particularly concerned with the provision of a four cylinder engine configuration embodying the fuel saving principles of the '769 patent, that may be better suited for cars and light-weight trucks. In accordance with the principles of the present invention, the four cylinder engine includes four piston and cylinder assemblies mounted in a frame structure in a row formation so that the outer two assemblies move together and in opposite directions to the two inner assemblies moving together. While the present invention has this characteristic in common with conventional four cylinder engines, it differs basically in that the outer assemblies, rather than being the same as the inner assemblies, are different from the inner assemblies. Specifically, the outer assemblies are valved to operate on a four-cycle basis while the inner assemblies are valved to operate on a two-cycle basis. The arrangement achieves one four-cycle drive stroke and two simultaneous two cycle drive strokes during each crankshaft rotation so that during a two revolution cycle involving four strokes of each cylinder, the drive stroke pattern which takes place includes the following in sequence: (1) one of the outer four cycle assemblies, (2) both of the inner two cycle assemblies together, (3) the other outer four cycle assembly, and (4) both of the inner two cycle assemblies together. Since the two inner two cycle assemblies are always operated together, they are subject to being selectively injected in one of three different ways: (1) both inner two cycle assemblies receive an injection directly, (2) both inner two cycle assemblies are skipped and receive no injection and (3) only one of the two inner two cycle assemblies receives an injection directly with the other skipped cylinder sharing a power event therewith in accordance with the teachings of the '769 patent.

With these options available, the engine when combined in a vehicle with an accelerator pedal, and computer control can be operated (1) in a minimum mode range corresponding to an initial range of pedal depression wherein the inner two cycle assemblies are skipped and only the two outer assemblies have a power event during each cycle (two out of a possible six are injected or a two-third saving of maximum fuel) (2) in an intermediate mode range corresponding to an intermediate range of movement of the accelerator pedal wherein one of the two inner assemblies receives an injection during each cycle so that the two share power events and the two outer assemblies have a power event (four out of a possible six are injected or a one-third saving of fuel) and (3) in a maximum mode range corresponding with a final range of pedal movement wherein all of the assemblies receive an amount of fuel by injection during each cycle resulting in each assembly having its own power event (six out of six—no fuel saving).

The computer may be constructed and arranged to vary the amount of fuel injected so that there is a smooth transmission from one range to the next. Thus the total amount of fuel injected at the end of the minimum range is the same as the total amount of fuel injected at the start of the intermediate range and so forth.

Other objects, features, and advantages of the present invention will become apparent from the following detailed description, the accompanying drawings, and appended claims.

### BRIEF DESCRIPTION OF THE DRAWINGS

FIG. 1 is a vertical sectional view taken along the plane of the axes of the four cylinders embodied in the engine of the present invention.

FIG. 2 is a schematic view showing the gaseous flow circuit for the engine shown in FIG. 1.

FIG. 3 is a schematic view of the engine shown in FIG. 1 embodied in an automotive vehicle having a computer and accelerator pedal for controlling the fuel injectors of the four assemblies, containing graphical illustrations of the operation when (A) in a minimum fuel mode (B) in an intermediate fuel mode and (C) in a maximum fuel mode.

### DETAILED DESCRIPTION

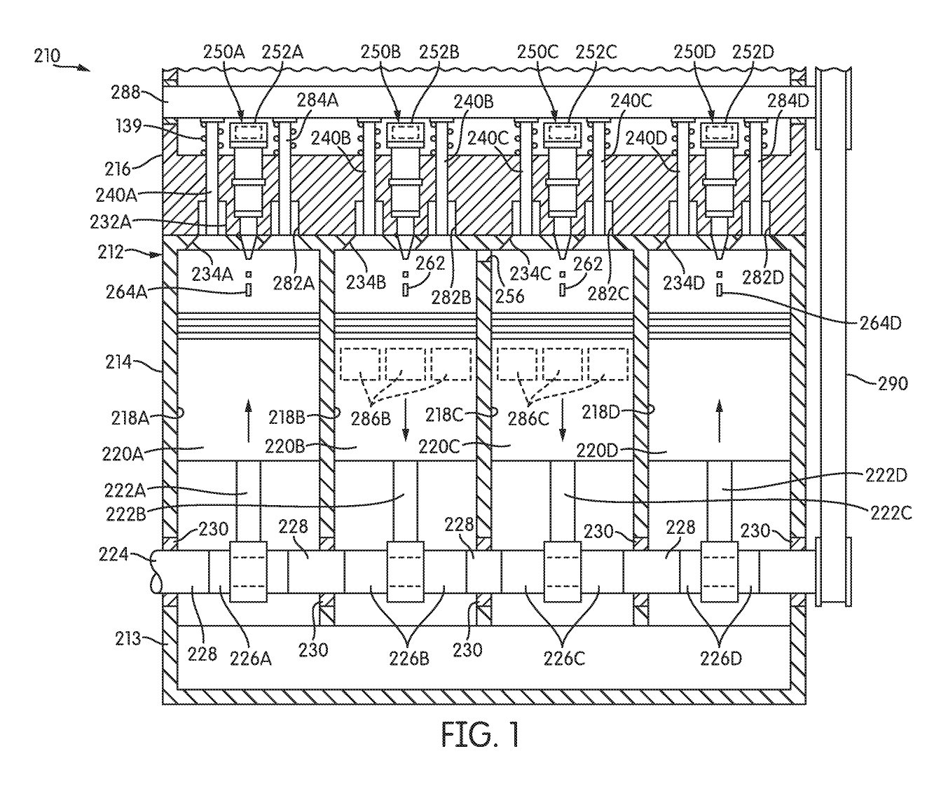

Referring now more particularly to FIG. 1, there is shown therein an internal combustion engine, generally indicated at 210, which embodies the principles of the present invention. The engine 210 includes a frame structure, generally indicated at 212, consisting of a lower pan section 213, an intermediate block section 214 detachably fixed on the pan section 213 and a head section 216 detachably fixed on the block section 214.

Formed in the block section 214 are four cylinders 218A, 218B, 218C and 218D disposed in a row formation. The cylinders 218A-D forms parts of conventional piston and cylinder assemblies which also include pistons 220A, 220B, 220C and 220D mounted in their respective cylinders for movement through successive strokes toward and away from the head section 216. The stroke movements are accomplished by piston rods 222A, 222B, 222C and 222D pivotally connected at one of their ends to the associated piston 220 and at their opposite ends to a crankshaft 224 through crank arm portions 226A, 226B, 226C and 226D, respectively formed on the crankshaft 224. The crankshaft 224 includes bearing portions 228 journaled in bearings 230 fixed between the pan section 213 and block section 214.

The two outer cylinders 218A and 218D are valved differently from the two inner cylinders 218B and 218C. The valving as shown includes two poppet valves in the upper end of each cylinder. Each poppet valves, which are to the left in each cylinder, is an inlet valve 240A, 240B, 240C and 240D, respectively, spring biased, as by springs 139, to seal on valve seats defining inlet openings 234A, 234B, 234C and 234D, respectively, for the cylinders.

The two right hand poppet valves of the inner two cylinders 218B and 218C referenced are also designated by the characters 240B and 240C, since they also serve as inlet valves for the two inner cylinders 218B and 218C. The two inner cylinders operate on a two cycle basis in which each cycle includes an upward compression stroke and a downward power stroke (also called the drive stroke). Toward the end of the downward power stroke, the pistons 220B and 220C downwardly pass and move into communication with a series of annularly spaced outlet openings 286B and 286C, respectively, formed in the wall of the cylinders 218B and 218C. When the outlet openings 286B and 286C are reached, the valves 240B and 240C are cammed to open by suitable cams on a camshaft 288 journaled on the head section 216. The camshaft 288 is connected to the crankshaft 226 by a motion transmitting assembly 290 which causes the camshaft 288 to rotate twice as fast as the crankshaft 224.

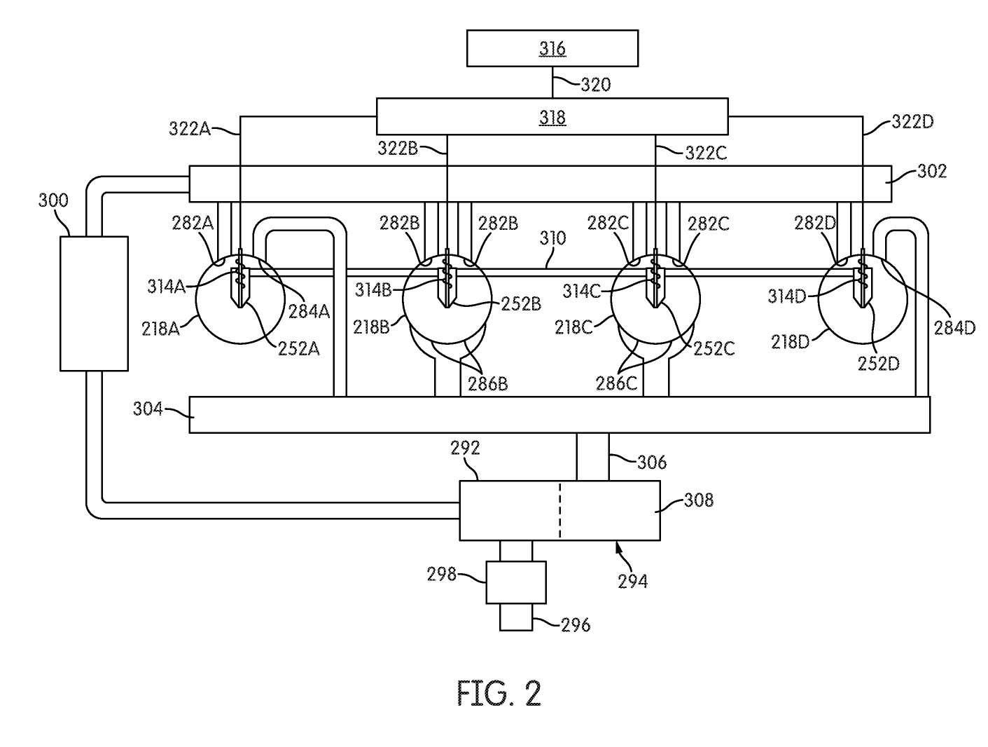

Referring now more particularly to FIG. 2, there is shown therein a flow diagram which enables an exchange of gases to take place within cylinders 220B and 220C when the inlet valves 240B and 240C are open and the pistons 220B and 220C have passed the outlet openings 286B and 286C.

As shown in FIG. 2, the gas entering the inlets 234B and 234C through open valves 240B and 240C comes from a supply of air under pressure created in the outlet of an air pump 292 forming an integral part of a turbocharger, generally indicated at 294. The air pump 292 draws air from an inlet 296 through an air filter 298, and pumps it through a heat exchanger 300 and into an inlet manifold 302. The air under pressure in the inlet manifold 302 is communicated with the inlets 234B and 234C by passages 282B and 282C.

The inlet manifold 302 is also communicated with the inlets 234A and 234D leading to the two outer cylinders 218A and 218D under the control of inlet poppet valves 240A and 240D. The two outer cylinders 218A and 218D are also controlled to operate on a four cycle basis by the conjunctive operation of two right hand exhaust or outlet poppet valves 284A and 284D respectively, spring biased to seal on outlet valve seats 282A and 282D respectively defining outlet openings for the two outer cylinders 218A and 218D. The four stroke cycle operation accomplishes four consecutive events in four consecutive strokes: (1) an inlet event (2) a compression event (3) a power event and (4) an exhaust or outlet event. The inlet and outlet valves 240A-D and 284A-D are closed during all the events except the inlet valves 240A and 240D are open during the inlet event and the outlet valves 284A and 284D are open during the outlet event.

Referring again to FIG. 2, the outlet openings 286B and 286C and the outlets 284A and 284D are all communicated with an outlet manifold 304 which, in turn, is communicated as by conduit 306 to a turbine 308 forming a part of the turbocharger 294. As is usual, the pressure from outlet manifold 304 impinges upon the turbine 308 to cause it to rotate which, in turn, causes the connected pump 292 to rotate and pressurize the drawn-in air through inlet 296 and air filter 298.

The diagrammatic view of FIG. 2 also illustrates schematically the fuel injectors 252A, 252B, 252C and 252D for the cylinders 218A-D respectively. The injectors 252 are communicated with a fuel line 310 containing fuel under pressure created by a pump and fuel source system. Each injector 252 includes an outlet valve which is spring biased closed and opened by the energization of a solenoid 314.

The diagrammatic view of FIG. 2 also indicates components of an automotive vehicle within which the engine 210 is suitably mounted. Thus, the vehicle includes a battery 316 (or other electrical power source, such as an alternator) by lead 320 capable of selectively controlling the energizations of the solenoids as by leads 322.

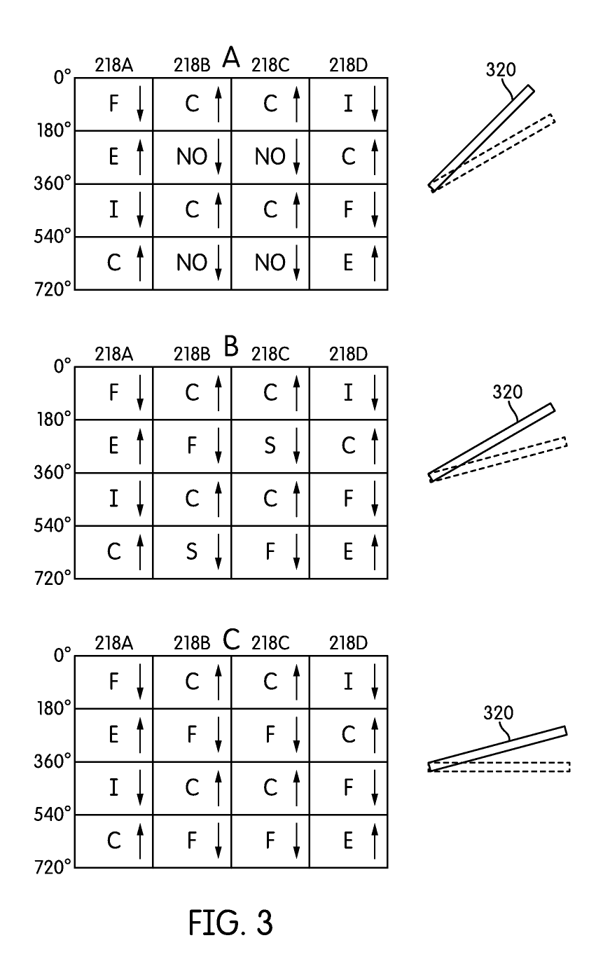

Referring now more particularly to FIG. 3, there is shown therein three charts representing three selective operations of the computer 318 in controlling the power level and speed of the engine 210. Each chart indicates the event occurring in each of the four cylinders during each piston stroke of 180° of crankshaft movement for a full cycle of 720°.

The power level variations are obtained by maintaining the injection of fuel into the two outer cylinders a single constant injection in each outer cylinder 218A or 218D during each cycle and varying the injection of fuel into the two inner cylinders 218B and 218C.

The fuel variation is controlled by the computer 318 in accordance with the position of an accelerator pedal 320 sensed by a sensor 322 connected to the computer 318 by lead 324. The variation also may be automatically controlled based on input of a cruise control system.

Chart A shown in FIG. 3A chart represents a minimum power level which is selected by the computer when the pedal 320 is in its fully extended position or a first third range of depressed movement therefrom. In this minimum power level mode, the computer is selectively operable to skip the injection to both the two inner cylinders 218B and 218C, so that during every stroke when the two outer cylinders 218A and 218D do not have a self-ignited firing event one of the outer cylinders has a firing event consisting of piston movement under compression pressure.

Chart B represents an intermediate level of power. This mode is chosen by the computer 318 when it senses that the pedal 320 has been depressed to move through an intermediate one third range of movement (or a similar intermediate position between a minimum and maximum). In this mode, the computer is operable to inject a charge of fuel into only one of the two inner cylinders 218B and 218C while the other one is skipped. In this mode, the one inner cylinder which receives the injection undergoes a self-ignited power event which is shared with the other inner cylinder by a passage 256 extending between them in accordance with the fuel saving principles of the '769 patent. The inner cylinders may alternate between receiving the fuel injection and receiving the shared pressure from the other as shown. Consequently, in the intermediate mode, during every other stroke when the two outer cylinder 218A and 218D do not have a self-ignited firing event, the two inner cylinders have a shared firing event.

Chart C represents a maximum power or speed level. This mode is chosen by the computer 318 when it senses that the pedal 320 has been depressed to move through a final one third range of movement. In this mode, the computer 318 is selectively operable to inject a charge of fuel in both inner cylinder 218B and 218C so that they have simultaneous self-ignited power events. Consequently, in the maximum power level mode, every other stroke when the two outer cylinders do not have a self-ignited power event, the two inner cylinders 218B and 218C have simultaneous self-ignited power strokes.

It can be seen that any time the engine 210 is moving the vehicle while the vehicle is coasting with the operators foot off of the pedal 320 or while the operator is braking the vehicle, the computer 318 chooses the low power level resulting in only 2 injections out of a possible six per cycle taking place for up to ⅔rds fuel saving. This minimum use of fuel continues as long as the pedal 300 is depressed within the first one third range of movement.

When acceleration beyond coasting is required, the operator depresses the pedal through the second one third range of movement. In this mode the sharing procedure takes place and there are 4 injections out of a possible 6 that take place (up to a ⅓ fuel saving). This mode is most likely to be in use most of the time during a typical truck haul.

The maximum power level which is shown in Chart C is not expected to be used except those situations when maximum power is required. There is no fuel saving in this mode but it is to be noted that the use of two cycle operation in the two inner cylinders 218B and 218C increases the maximum power of the engine 210 by 50% as compared with a conventional 4 cylinder four stroke engine, which added power on occasion is highly desirable to have.

The present engine 210 is advantageous when compared with a 4 cylinder/4 stroke engine capable of skipping two cylinders, not only in providing unavailable power even though both use only two injections when coasting or braking. The conventional engine uses four injections most of the time, while the present engine uses 4 injections in intermediate mode. But the power sharing event between the inner piston/cylinders increases the power available at any given fuel amount so that an estimated saving of 30% is obtained over conventional operation.

Finally, it will be understood that the computer 318 is constructed and arranged to vary the amount of fuel injected so that there is a smooth transmission from one range to the next. For example, the total amount of fuel injected at all fuel-receiving cylinders at the end of the minimum range may be the same amount of fuel injected at the start of the intermediate range and so forth.

It is important to note that while the present engine is constructionally similar to a conventional four cylinder engine, it is capable of generating power from six injections each cycle rather than just four. Consequentially, the present engine offers a 50% increase in power as compared with a conventional four cylinder engine. In the minimum fuel mode of the present engine it uses only 33⅓ of the maximum. Even so, this 66⅔% saving achieved by 2 injections in the two outer cycle assemblies per cycle is equal to the 50% saving in a conventional 4 cylinder engine capable of skipping 2 cylinders. The 66⅔% saving is achieved any time during operation of the vehicle when the operator takes his foot off the accelerator to brake or let up on it when coasting.

The conventional 4 cylinder engine capable of skipping 2 cylinders must operate on all four cylinders anytime the accelerator pedal is depressed to maintain the speed or increase the speed of the vehicle, which is the situation during a large part of the time the vehicle is moving. The present engine can operate in intermediate mode for this more frequent operation saving 33⅓ of the maximum fuel that can be used.

In this intermediate mode, 4 injections take place, the same number as in a conventional skipping 4 cylinder engine. However, because of the sharing of power events, a lesser amount of fuel is needed in the present engine to reach the same power level achieved in the conventional skipping engine. This difference results in an estimated 30% fuel saving in comparison to conventional anytime the present engine is operating in the more frequent intermediate mode.

There is no fuel saving when operating the present engine in maximum fuel mode but the conventional cylinder skipping engine is incapable of operating at this power level so it is rarely used in the operation of the present engine, but nice to have when the rare occasion arises.

1. An internal combustion engine comprising:
a frame structure
four piston and cylinder assemblies carried by said frame structure, and
a crank shaft carried by said frame structure for rotational movement about a crankshaft axis,
said four assemblies including:
(1) two outer cylinders and two inner cylinders disposed on said frame structure in a row formation;
(2) two outer pistons and two inner pistons connected with said crank shaft so as to move within said two outer cylinders and said two inner cylinders, respectively, through two strokes in opposite directions during each revolution of said crankshaft,
(3) outer valving structure operatively associated with said two outer cylinders and pistons constructed and arranged to cause a repetitious cycle of events to occur in each said outer cylinders during every four strokes of each said piston therein, each cycle including successive compression and power events during one revolution of said crankshaft and successive exhaust and intake events during the next revolution of said crankshaft,
(4) inner valving structure operatively associated with said two inner cylinders and pistons constructed and arranged to cause a repetitious cycle of events to occur in each said inner cylinders during every two strokes of each said piston therein, each cycle including successive compression and power strokes during one revolution of said crankshaft and simultaneous exhaust and intake events during the final portion of the power event and beginning portion of the compression event,
the arrangement being such that during two revolutions of said crankshaft, successive power events occur (1) in one outer cylinder (2) in two inner cylinders together (3) in the other outer cylinder and (4) in two inner cylinders together,
each piston and cylinder assembly including a fuel injector constructed and arranged to be controlled to inject an amount of fuel into the associated cylinder during each cycle so that the associated cylinder undergoes a self-ignited power event, and
a computer constructed and arranged to selectively control the injectors in one mode wherein the two outer cylinders, and only one of the two inner cylinders receive an amount of fuel while the other one of the two inner cylinders is skipped and receives no fuel injection,
the two inner cylinders being intercommunicated so the self-ignited power event occurring in said one mode in the inner cylinder which received an amount of fuel is shared in the skipped cylinder.

2. An internal combustion engine as defined in claim 1 wherein said computer is constructed and arranged to control the injectors in a second mode wherein the inner cylinder skipped during each cycle of operation in said one mode has an amount of fuel injected therein so that all cylinders have self-ignited power events therein during each cycle.

3. An internal combustion engine as defined in claim 2 wherein said inner valve structure includes cam controlled inlet valve normally closing an inlet opening leading into one end of the associated cylinder movable by cam activation from closing relation with respect to inlet opening to an opening relation with respect to said inlet opening during the inlet event and simultaneous exhaust and intake events, and an exhaust opening in a cylinder wall defining the associated inner cylinder in a position spaced from said inlet opening to controlled by the position of movement of the associated piston so that the contents of the cylinder between said inlet opening and said piston is closed off from the exhaust opening by the position of movement of the position away from said inlet opening and (2) communicated with said exhaust opening by the movement of the piston thereby.

4. An internal combustion engine as defined in claim 3 wherein the power event in said one of said inner and outer assemblies is accomplished by compressing a charge of air during the compression stroke into a self-ignited pressure and temperature and igniting the compression air by the injection of an amount of fuel therein.

5. An internal combustion engine as defined in claim 3 wherein the power event one of said inner and outer assemblies is accomplished by injecting the amount of fuel so as to mix with air during the intake event, compressing the fuel air mixture during the compression event and energizing a spark plug in communication with the compressed air fuel mixture to ignite the same.

6. The combination of a vehicle having an accelerator pedal and an engine as defined in claim 1 constructed and arranged to move the vehicle by the manual depression of the pedal from a normal idle position to a maximum power position, said engine being operable in said second mode when said pedal is in a maximum position range thereof and operable in said one mode when said pedal is an intermediate position range, the combination as defined in claim 6 said computer being constructed and arranged to control said injectors to operate in an minimum mode wherein the outer cylinders receive an amount of fuel and both of said inner cylinders are skipped so that neither one receives an amount of fuel during each cycle when said pedal is in a normal idle positions range.

7. The combination as defined in claim 7 wherein said computer is constructed and arrange to control said injectors so that the total amount of fuel injected during each cycle is gradually increased as the pedal is moved through its normal idle position range to its maximum position range.
